(19) United States
(12) Patent Application Publication
(10) Pub. No.: US 2022/0388283 A1
(43) Pub. Date: Dec. 8, 2022

(54) LOW COST AND HIGH STRENGTH WOODEN PRODUCT USING WASTE WOOD PIECES

(71) Applicant: Saglamlar Orman Tarim Urunleri Ticaret Ve Sanayi Anonim Sirketi, Edremit, Balikesir (TR)

(72) Inventor: Mithat Rustu SAGLAM, Edremit, Balikesir (TR)

(21) Appl. No.: 17/771,257

(22) PCT Filed: May 8, 2020
(86) PCT No.: PCT/TR2020/050403

§ 371 Date: Apr. 22, 2022

(30) Foreign Application Priority Data
Mar. 13, 2020 (TR) 2020/03960

(51) Int. Cl. B32B 21/02; B32B 21/04; B32B 7/12; B32B 7/03

(52) U.S. Cl. CPC B32B 21/02; B32B 21/042; B32B 7/12; B32B 7/03; B32B 2250/40

(57) ABSTRACT

A low cost and high strength wooden product which has been developed as an alternative to plywood and oriented strand boards (OSB), can be used in all areas where the plywood is used, in which the wooden papels can be used with glued waste wood pieces in the vertical and horizontal directions in its content, and can be produced with or without film.

### TECHNICAL FIELD

The invention relates to a low cost and high strength wooden product which has been developed as an alternative to plywood and oriented strand boards (OSB), can be used in all areas where the plywood is used, in which the wooden papels can be used with glued waste wood pieces in the vertical and horizontal directions in its content, and can be produced with or without film.

### THE STATE OF THE ART

Nowadays, all kinds of panels like plywood and oriented strand boards are widely used required in the area required, in other words in construction molds, floor construction, frame construction, roof construction etc. The leaves obtained by peeling from a tree trunk are called wooden papels. Glue is applied between these papels and plywood is produced by putting on top of each other and waiting in hot presses. While putting the papels on top of each other, they are lined up by following the order in the vertical and horizontal directions. This stacking order increases the strength of the product.

The existing plywood products consist of multiple layers of papels lined up by putting on top of each other. While these papels are put on top of each other, they are lined up in the vertical and horizontal direction, glue is applied between them, and plywood production is completed by waiting them in hot presses. Compared with the product according to the invention, for a plywood of the same thickness, 7, 9 or 13 layers of papel should be used as an example for 18 mm plywood. Wood papels are high cost products. Therefore, the plywood produced in the present art is costly as it contains a large number of wood papel layers. Since the number of papel layers is high, the number and amount of surface on which glue should be applied also increases. In this case, it complicates the process and increases the process time and costs.

As a result, the existence of the above problems and the inadequacy of the existing products made it necessary to make a development in the relevant technical field.

### Object of the Invention

The main object of the invention is to develop a low cost and high strength wooden product which has been developed as an alternative to plywood and oriented strand boards (OSB), in which the wooden papels can be used with glued waste wood pieces in the vertical and horizontal directions in its content, and can be produced with or without film.

Another object of the invention is to provide recycling of wood production waste. In the prior art, a lot of chip waste is generated during the production of wooden products. These chips are generally utilized by burning them. However, in the product according to the invention, wood production wastes are used again by mixing with glue.

Another object of the invention is to reduce the product cost and increase the product strength by using wood production wastes (waste wood chips, paper, sawdust, paddy husk, nutshell etc.) as a filling material in the product content of the invention by mixing them with glue.

Another object of the invention is to significantly reduce the production cost as fewer papel layers are used compared to plywood production. In the prior art, instead of plywood produced using between 3 to 30 layers of papels according to thickness, the production of wooden product were provided with the same strength by using only 4 layers of papel.

### DESCRIPTION OF THE DRAWINGS

FIG. 1: Is the schematic sectional view showing the product layers according to the invention.

### THE DESCRIPTION OF THE PIECE REFERENCES

A. Wooden product

1. Upper film layer

2. First outer papel

3. Glue

4. First inner papel

5. Filling layer

6. Second inner papel

7. Second outer papel

8. Lower film layer

### DETAILED DESCRIPTION OF THE INVENTION

The invention relates to a low cost and high strength wooden product (A) which has been developed as an alternative to plywood and oriented strand boards (OSB), can be used in all areas where the plywood and OSB are used, in which the wooden papels can be used with glued waste wood pieces in the vertical and horizontal directions in its content, and can be produced with or without film.

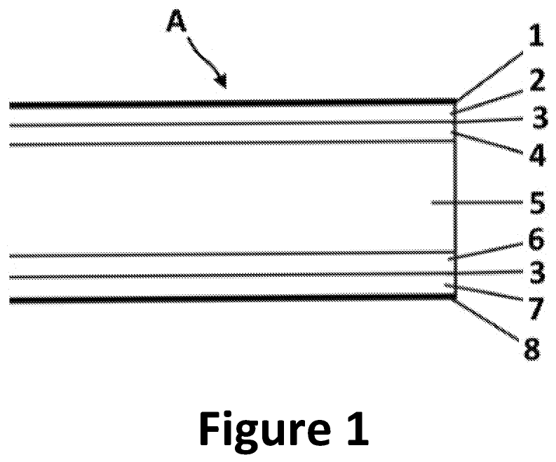

In FIG. 1, the schematic sectional view showing the product layers according to the invention is given. The wooden product (A) according to the invention can be produced with or without film. As seen in FIG. 1, from top to bottom, the wooden product (A), respectively, includes a upper film layer (1), a first outer papel (2) cut in the vertical and horizontal directions, a first inner papel (2) cut differently in the vertical and horizontal directions relative to the first outer papel (2), the glue (3) used between the first outer papel (2) and the first inner papel (4), a filling layer (5) composed of the wooden production waste (waste wood chips, paper, sawdust, paddy husk, nutshell , etc.) and glue mixture, a second inner papel (6) cut into in the vertical and horizontal directions, a second outer papel (7) cut differently in the vertical and horizontal directions relative to the second inner papel (6), the glue (3) used between the second inner papel (6) and the second outer papel (7) and a lower film layer (8) undermost.

The wooden product (A) according to the invention can be produced preferably without film. In this case, the upper film layer (1) and the lower film layer (8) will not be on the product.

The production process of the wooden product (A) according to the invention is as follows. If production with film is desired, the lower film layer (8) is laid on the bottom. The lower film layer (8) is self-adhesive, when heated in the press the feature of adhesion appears, therefore it is not necessary to apply glue on the lower film layer (8).

A second outer papel (7) is laid on the lower film layer (8). Here, the most important point is that if the second outer papel (7) is placed in the vertical direction, the second inner papel (6) on the second outer papel (7) is placed in the horizontal direction. If the second outer papel (7) is placed in the horizontal direction, the second inner papel (6) on it is placed in the vertical direction. The aim of this is robustness. If a tree is divided into vertical strips, it is cut into in the vertical direction (it comes from the water path, it means cutting parallel to the water path in the tree). If a steep tree is cut into horizontal stripes, this is called the horizontal direction.

A glued second inner papel (6) is placed on the second outer papel (7) and the two papel layers adhere to each other with glue. Here, two papel has been placed in the vertical and horizontal directions. Also, these can be placed in the horizontal and vertical directions, what matters most is to place two papels in opposite stripes to each other. I other words, if the second outer papel (7) is used in the vertical direction, the second inner papel (6) is used in the horizontal direction. Or it may be the opposite.

A filling layer (5) forming the middle-inner region of the wooden product (A) is laid on the prepared papels. The filling layer (5) consists of wood production waste mixed with glue. As wood production waste, waste wood chips, paper, sawdust, paddy husk, nutshell, etc. can be used.

A first inner papel (4) is placed on the filling layer (5) (glued wood chips, etc.). The upper portion of the first inner papel (4) is glued. Since the bottom of it is placed on the chips the chips that are already glued, there is no need for additional gluing, or both sides of it can be glued.

A first outer buffer (2) is placed on top of the first glued inner papel (4) by paying attention to its principal of vertical and horizontal directions.

The upper film layer (1) is laid on the top.

After all layers are placed on top of each other, they are kept in a hot press and hence, all layers are adhered to each other and these become final products.

1. A low cost and high strength wooden product which has been developed as an alternative to plywood and oriented strand boards (OSB), can be used in all areas where the plywood is used, in which the wooden papels can be used in the vertical and horizontal directions in its content, wherein said wooden product includes:
a first outer papel cut into in the vertical and horizontal directions, a first inner papel cut into differently in the vertical and horizontal directions relative to the first outer papel;
glue used between the first outer papel and the first inner papel;
a filling layer; and
a second inner papel cut into in the vertical and horizontal directions, a second outer papel cut into differently in the vertical and horizontal directions relative to the second inner papel.

2. The wooden product according to claim 1, wherein if production with film is desired, it includes a lower film layer laid on the bottom of the second outer papel.

3. The wooden product according to claim 1, wherein if production with film is desired, it includes an upper film layer laid on the top of the first outer papel.

4. The wooden product according to claim 1, wherein said filling layer is composed of the mixture of the wooden production waste and glue.

5. The wooden product according to claim 3, wherein waste wood chips, paper, sawdust, paddy husk, nutshell, etc. can be used as wood production waste.
